(19) United States
(12) Patent Application Publication
(10) Pub. No.: US 2014/0315067 A1
(43) Pub. Date: Oct. 23, 2014

(54) METHODS OF MAKING MICROPOROUS POLYMERIC MEMBRANES AND THE USE OF SUCH MEMBRANES AS BATTERY SEPARATOR FILM

(71) Applicant: Toray Battery Separator Film Co., Ltd., Nasushiobara-shi (JP)

(72) Inventor: Kazuhiro Yamada, Nasushiobara-shi (JP)

(73) Assignee: Toray Battery Separator Film Co., Ltd., Nasushiobara-shi (JP)

(21) Appl. No.: 14/275,049

(22) Filed: May 12, 2014

Related U.S. Application Data
(62) Division of application No. 13/058,938, filed on Feb. 14, 2011.
(60) Provisional application No. 61/093,625, filed on Sep. 2, 2008.

(30) Foreign Application Priority Data
Oct. 22, 2008 (EP) 08167305.5

(51) Int. Cl. H01M 2/16; B29C 47/06; H01M 2/14

(52) U.S. Cl. CPC H01M 2/1686; H01M 2/145; B29C 47/065
USPC 429/145; 264/173.12; 264/173.15

(57) ABSTRACT

A method of producing a microporous membrane includes combining at least a first polyethylene and a first diluent; combining at least a second polyethylene and a second diluent; combining at least a third polyethylene and a third diluent; forming from the combined polyethylenes and diluents a multi-layer extrudate having a first layer containing the first polyethylene, a second layer containing the second polyethylene, and a third layer located between the first and second layers containing the third polyethylene, wherein the extrudate contains polyethylene having a terminal unsaturation ≧0.20 per 10,000 carbon atoms in an amount of 4.0 wt. % to 35.0 wt. %; and removing at least a portion of the first, second, and third diluents from the multi-layer extrudate to produce the membrane.

### TECHNICAL FIELD

This disclosure relates to a microporous membrane having a shutdown temperature 133.0° C. and a self-discharge capacity 110.0 mAh, e.g., ≦90.0 mAh. The disclosure also relates to a battery separator formed by such a microporous membrane and a battery comprising such a separator. Another aspect relates to a method of making the microporous membrane, a method for making a battery using such a membrane as a separator, and a method for using such a battery.

### BACKGROUND

Microporous membranes can be used as battery separators in, e.g., primary and secondary lithium batteries, lithium polymer batteries, nickel-hydrogen batteries, nickel-cadmium batteries, nickel-zinc batteries, silver-zinc secondary batteries, etc. When microporous membranes are used as battery separators, particularly lithium ion battery separators, the membranes' performance significantly affects the properties, productivity and safety of the batteries. Accordingly, the microporous membrane should have suitable mechanical properties, heat resistance, permeability, dimensional stability, shutdown properties, meltdown properties, etc. It is desirable for the batteries to have relatively high permeability, relatively high pin puncture strength, relatively low shutdown temperature, and relatively high electrochemical stability, particularly for batteries that are exposed to high temperatures during manufacturing, charging, re-charging, overcharging, use, and/or storage. High separator permeability generally leads to an improvement in the battery's power and capacity. Low shutdown temperature is desired for improved battery safety, particularly when the battery is operated under overcharge conditions. High pin puncture strength is desired to prevent separator puncture during battery manufacturing, which can result in an internal short circuit. High electrochemical stability is desired because electrochemical deterioration of the separator can lead to battery self-discharge.

In general, batteries containing microporous membrane separators produced from polyethylene having a relatively large amount of terminal unsaturation exhibit a decrease in battery capacity after storage at relatively high temperature. This effect, called “self-discharge capacity,” has been attributed to oxidation of the separator surface. Oxidation has been observed on the separator's cathode side in batteries using an LiPF6-based electrolyte, particularly when the battery is operated at a relatively high voltage and elevated temperature (such as 4.2 V and 60° C.). Separator oxidation is generally irreversible. On the other hand, battery separators produced from polyethylene having a significant amount of terminal unsaturation also have a relatively low shutdown temperature which is beneficial. See, for example, WO 97-23554 A and JP 2002-338730 A, which disclose microporous film having a relatively low shutdown temperature.

Other references disclose multi-layer membranes having an improved balance of properties. WO 2007/037290 A, for example, discloses a battery separator comprising a multi-layer, porous film having two microporous layers. The first layer contains polyethylene having a terminal unsaturation of 0.20 or more per 10,000 carbon atoms, while the second layer contains a second polyethylene having a terminal unsaturation of less than 0.20 per 10,000 carbon atoms.

It would be desirable to further improve the total balance of film properties such as permeability, pin puncture strength, heat shrinkage, shutdown temperature and electrochemical stability, particularly in a multi-layer membrane.

### SUMMARY

I provide a microporous membrane comprising polyolefin and having a shutdown temperature ≦133.0° C., and a self-discharge capacity ≦110.0 mAh.

I also provide methods of producing a microporous membrane comprising:
(1) (a) combining at least a first polyethylene and a first diluent, the first polyethylene having an Mw<1.0×10⁶ and an amount of terminal unsaturation <0.20 per 10,000 carbon atoms and (b) combining at least a second polyethylene and a second diluent, the second polyethylene having an Mw<1.0×10⁶ and an amount of terminal unsaturation <0.20 per 10,000 carbon atoms;
(2) combining at least a third polyethylene and a third diluent, the third polyethylene having an Mw<1.0×10⁶ and an amount of terminal unsaturation 0.20 per 10,000 carbon atoms;
(3) forming from the combined polyethylenes and diluents to produce a multi-layer extrudate having a first layer containing the first polyethylene, a second layer containing the second polyethylene, and a third layer located between the first and second layers containing the third polyethylene, wherein the extrudate contains polyethylene having a terminal unsaturation 0.20 per 10,000 carbon atoms in an amount in the range of 4.0 wt. % to 35.0 wt. % based on the total weight of polymer in the extrudate; and
(4) removing at least a portion of the first, second, and third diluents from the multi-layer extrudate to produce the membrane.

I further provide a microporous membrane produced by the preceding process.

I still further provide a multi-layer microporous membrane comprising:
a first layer comprising a first polyethylene having an Mw<1.0×10⁶ and an amount of terminal unsaturation <0.20 per 10,000 carbon atoms;
a second layer comprising a second polyethylene having an Mw<1.0×10⁶ and an amount of terminal unsaturation <0.20 per 10,000 carbon atoms;
a third layer located between the first and second layers, the third layer comprising a third polyethylene having an Mw<1.0×10⁶ and an amount of terminal unsaturation ≧0.20 per 10,000 carbon atoms; and
the total amount of polyethylene in the multi-layer microporous membrane having terminal unsaturation 0.20 per 10,000 carbon atoms and an Mw<1.0×10⁶ of 4.0 wt. % to 35.0 wt. %, based on the total weight of the multi-layer microporous membrane.

I yet further provide a battery comprising an anode, a cathode, an electrolyte, and at least one battery separator located between the anode and the cathode, the battery separating comprising the microporous membrane of any of the preceding examples. The battery can be, e.g., a lithium ion primary or secondary battery. The battery can be used, for example, as a power source for a lap top computer, a mobile phone, a power tool such as a battery-operated saw or drill, or for an electric vehicle or hybrid electric vehicle.

### DETAILED DESCRIPTION

Microporous membranes comprising polyethylene having an amount of terminal unsaturation 0.20 per 10,000 carbon atoms have been disclosed for use as battery separators. These separators have a relatively low shutdown temperature, which leads to improved battery safety as disclosed in WO 97-23554 A and JP 2002-338730 A. On the other hand, microporous membranes comprising polyethylene having a significant amount of terminal unsaturation have been observed to deteriorate during battery storage and use. It is believed that the deterioration results at least in part from polyethylene oxidation reactions. Microporous membranes comprising polyethylene having an amount of terminal unsaturation <0.20 per 10,000 carbon atoms have also been disclosed as useful for battery separators. Batteries containing these separators show less deterioration during battery storage and use, but these batteries have a higher shutdown temperature. I discovered a microporous film that has both a low shutdown temperature and less separator deterioration (greater electrochemical stability) during battery storage and use.

The microporous membrane may be a multi-layer membrane having first and second layers comprising first polyethylene and second polyethylenes respectively. The first and second polyethylenes are optionally the same polyethylene or mixture of polyethylenes. The first and second polyethylenes have an amount of terminal unsaturation <0.20 per 10,000 carbon atoms (PE1, PE2). The multi-layer microporous membrane also contains a third layer located between the first and second layers, wherein the third layer comprises a third polyethylene having an amount of terminal unsaturation ≧0.20 per 10,000 carbon atoms (PE3). It has been discovered that the first and second layers provide improved electrochemical stability during battery storage and use. Moreover, the first and second layers do not appear to significantly affect the desirably low shutdown temperature provided by the third layer.

Monolayer microporous membranes containing polyethylene having an amount of terminal unsaturation ≧0.20 per 10,000 carbon atoms have been disclosed in, e.g., WO 2007/037290 A. Monolayer microporous membranes of PE1 or PE2 exhibit relatively good electrochemical stability but have undesirably higher shutdown temperatures, whereas the monolayer membrane of PE3 exhibits lower shutdown temperatures, but has relatively poor electrochemical stability. Tri-layer membranes having an inner layer of PE1 or PE2 and outer layers of PE3 have also been disclosed in WO 2007/037290 A. Those membranes do not have the desirable electrochemical stability of a monolayer microporous membrane of PE1 or PE2, but do have a desirable shutdown temperature that is lower than the shutdown temperature of a PE1 or PE2 monolayer microporous membrane. It is therefore surprising that a multi-layer microporous membrane containing a core layer of PE3 and outer layers of PE1 and/or PE2 would have both improved electrochemical stability and improved shutdown temperature.

### (1) COMPOSITION AND STRUCTURE OF THE MICROPOROUS MEMBRANE

The microporous membrane may comprise:
a first layer comprising PE1 having a weight-average molecular weight (“Mw”)<1.0×10⁶, e.g., of from 1.0×10⁵ to 0.95×10⁶, and an amount of terminal unsaturation of less than 0.20 per 10,000 carbon atoms; a second layer comprising PE2 having an Mw<1.0×10⁶, e.g., of from 1.0×10⁵ to 0.95×10⁶, and an amount of terminal unsaturation <0.20 per 10,000 carbon atoms; and a third layer comprising PE3 having an Mw<1.0×10⁶, e.g., of from 1.0×10⁵ to 1.0×10⁶, and an amount of terminal unsaturation (e.g., terminal carbon-carbon unsaturated bonds)≦0.20 per 10,000 carbon atoms. The third layer is located between the first and second layers. The total amount of the PE3 in the membrane is generally from about 4.0 wt. % to 35.0 wt. %, or from about 5.0 wt. % to 25.0 wt. %, the weight percents being based on the weight of the membrane, e.g., the total weight of polymer in the membrane when the membrane comprises solely polymer and pores. The thickness of the third layer is generally about 4.0% to about 21.0%, or from about 10.0% to about 20.0%, or from 10.0% to about 15.0% of the combined thickness of the first, second and third layers. The first and second layers may contain less than 5.0 wt. % or less than 1.0 wt. % of PE3, and the third layer contains less than 5.0 wt. % or less than 1.0 wt. % of PE1, PE2, or both PE1 and PE2. The first, second, and third layers may consist essentially of polymer. The first, second, and third layers may consist essentially of polyethylene or polyethylene and one or more of antioxidant, inert filler and the like.

The multi-layer microporous membrane may further comprise a fourth polyethylene, the fourth polyethylene (PE4) having an Mw of 1.0×10⁶. The first layer may consist essentially of PE1 optionally in combination with PE4, the second layer may consist essentially of PE2 optionally in combination with PE4, and the third layer may consist essentially of PE3 optionally in combination with PE4.

The multi-layer, microporous membrane may comprise three layers, wherein the first and second layers (also called the “surface” or “skin” layers) comprise outer layers of the membrane and the third layer is an intermediate layer (or “core” layer) located between the first and second layers. Alternatively, the multi-layer, microporous membrane can comprise additional layers, i.e., in addition to the two skin layers and the core layer. For example, the membrane can contain additional core layers. The membrane can be a coated membrane, i.e., it can have one or more layers additional layers on or applied to the first and second layers. While it is not required, the core layer can be in contact with one or more of the skin layers in a stacked arrangement such as A/B/A with face-to-face (e.g., planar) stacking of the layers. The membrane can be referred to as a “polyolefin membrane” when the membrane contains polyolefin. While the membrane can contain polyolefin only, this is not required, and it is within the scope of this disclosure for the polyolefin membrane to contain polyolefin and materials that are not polyolefin. The membrane may consist of polyethylene or consists essentially of polyethylene.

Although it is not required, the first and second layers can have the same thickness and composition. The thickness of the first and second layers can optionally be in the range of 79.0% to 96.0% of the total thickness of the multi-layer microporous membrane. For example, the thickness can be 80.0% to 90.0%, or 85.0% to 90.0%. Optionally, the amount of PE1 in the first layer is 55.0 wt. % to 100.0 wt. %, or 65.0 wt. % to 85.0 wt. %, based on the weight of the first layer. When the first layer contains PE4, the amount of PE4 in the layer is ≦45.0 wt. %, e.g., 15.0 wt. % to 40.0 wt. %, based on the weight of the layer. Optionally, the amount of PE2 in the second layer is 55.0 wt. % to 100.0 wt. %, or 65.0 wt. % to 85 wt. %, based on the weight of the second layer. When the second layer contains PE4, the amount of PE4 in the layer is 45.0 wt. %, e.g., 15.0 wt. % to 40.0 wt. %, based on the weight of the layer. PE1 and PE2 may be the same polyethylene. In other words, the first and second layers can comprise PE1, or the same mixture of PE1 and PE4, for example.

The amount of PE3 in the third layer may be 55.0 wt. % to 100.0 wt. %, or 60.0 wt. % to 85.0 wt. %, based on the weight of the layer. When the third layer contains PE4, the amount of PE4 in the layer is ≦45.0 wt. %, e.g., 15.0 wt. % to 40.0 wt. %, based on the weight of the layer.

Besides the PE1, PE2, PE3, and PE4, the membrane can optionally contain other polyolefins such as polypropylene.

The membrane may be a polyethylene membrane where the thicknesses of the first and second layers are equal (and of substantially the same composition), with both layers being from about 80.0% to about 95.0%, for example, about 85.0% of the combined thickness of the first, second, and third layers. The first and second layer both comprise PE1 in an amount of from about 65.0 wt. % to 85.0 wt. %, for example, 70.0 wt. %. The amount of PE3 in the third layer is from about 60.0 wt. % to 85.0 wt. %, for example, 70.0 wt. %. The amount of PE4 in the first and second layers is from 15.0 wt. % to 35.0 wt. %, for example, 30.0 wt. %, while the amount of PE4 in the third layer is 15.0 wt. % to 40.0 wt. %, for example, 30.0 wt. %.

The PE1, PE2, PE3, PE4, and the diluents used to produce the extrudate and the microporous membrane will now be described in more detail. While the disclosure is described in terms of these examples, it is not limited thereto, and the description is not meant to foreclose other examples within the broader scope of this disclosure. In particular, the description of multi-layer membranes is not meant to foreclose monolayer structures within the broader scope of the disclosure.

### (2) MATERIALS USED TO PRODUCE THE MULTI-LAYER MICROPOROUS MEMBRANE

### Polymer Used to Produce the Multi-Layer, Microporous Membrane

The first polyethylene (PE1) can be a high density polyethylene (HDPE) having an Mw<1.0×10⁶, e.g., of from about 2.0×10⁵ to about 0.90×10⁶, a molecular weight distribution (“MWD”) of from about 2.0 to about 50.0, and a terminal unsaturation amount <0.20 per 10,000 carbon atoms. PE1 has an Mw of from about 4.0×10⁵ to about 6.0×10⁵, and an MWD of from about 3.0 to about 10.0. PE1 may have an amount of terminal unsaturation 0.14 per 10,000 carbon atoms, or ≦0.12 per 10,000 carbon atoms, e.g., in the range of 0.05 to 0.14 per 10,000 carbon atoms (e.g., below the detection limit of the measurement). PE2 can be selected from among the same polyethylenes as PE1. PE1 and PE2 can be, e.g., SUNFINE SH-800™ polyethylene, available from Asahi Kasei.

PE3 can also be a HDPE having an Mw<1.0×10⁶, e.g., of from about 2.0×10⁵ to about 0.9×10⁶, an MWD of from about 2 to about 50, and having a terminal unsaturation amount ≧0.20 per 10,000 carbon atoms. PE3 may have an amount of terminal unsaturation ≧0.30 per 10,000 carbon atoms, or ≧0.50 per 10,000 carbon atoms, e.g., of 0.6 to 10.0 per 10,000 carbon atoms. A non-limiting example of the PE3 for use herein is one having an Mw of from about 3.0×10⁵ to about 8.0×10⁵, for example, about 7.5×10⁵, and an MWD of from about 4 to about 15. PE3 can be, e.g., Lupolen™, available from Basell.

PE1, PE2, and/or PE3 can be, e.g., an ethylene homopolymer or an ethylene/α-olefin copolymer containing 5 mole % of one or more α-olefin comonomers. Optionally, the α-olefin comonomers, which are not ethylene, are one or more of propylene, butene-1, pentene-1, hexene-1,4-methylpentene-1, octene-1, vinyl acetate, methyl methacrylate, or styrene. PE1 and PE2 can be produced, e.g., in a process using a Ziegler-Natta or single-site polymerization catalyst, but this is not required. The amount of terminal unsaturation can be measured in accordance with the procedures described in PCT Publication WO 97/23554, for example. PE3 can be produced using a chromium-containing catalyst, for example.

PE4 can be, for example, an ultra-high molecular weight polyethylene (UHMWPE) having an Mw≧1.0×10⁶, e.g., of from about 1.0×10⁶ to about 5.0×10⁶ and an MWD of from about 2 to about 50. A non-limiting example of PE4 for use herein is one that has an Mw of from about 1.0×10⁶ to about 3.0×10⁶, for example, about 2.0×10⁶, and an MWD of from about 2 to about 20, preferably about 4 to 15. PE4 can be, e.g., an ethylene homopolymer or an ethylene/α-olefin copolymer containing 5 mole % of one or more α-olefin comonomers. The α-olefin comonomers can be, for example, one or more of, propylene, butene-1, pentene-1, hexene-1,4-methylpentene-1, octene-1, vinyl acetate, methyl methacrylate, or styrene. Such copolymer can be produced using a Ziegler-Natta or a single-site catalyst, though this is not required. Optionally, PE4 is Hi-ZEX 240-m™ polyethylene, available from Mitsui.

Mw and MWD of the polyethylenes are determined using a High Temperature Size Exclusion Chromatograph, or “SEC,” (GPC PL 220, Polymer Laboratories), equipped with a differential refractive index detector (DRI). Three PLgel Mixed-B columns (available from Polymer Laboratories) are used. The nominal flow rate is 0.5 cm³/min, and the nominal injection volume was 300 μL. Transfer lines, columns, and the DRI detector are contained in an oven maintained at 145° C. The measurement is made in accordance with the procedure disclosed in Macromolecules, Vol. 34, No. 19, pp. 6812-6820 (2001).

The GPC solvent is filtered Aldrich reagent grade 1,2,4-Trichlorobenzene (TCB) containing approximately 1000 ppm of butylated hydroxy toluene (BHT). The TCB is degassed with an online degasser prior to introduction into the SEC. Polymer solutions are prepared by placing dry polymer in a glass container, adding the desired amount of above TCB solvent, then heating the mixture at 160° C. with continuous agitation for about 2 hours. The concentration of polymer solution is 0.25 to 0.75 mg/ml. Sample solution will be filtered off-line before injecting to GPC with 2 μm filter using a model SP260 Sample Prep Station (available from Polymer Laboratories).

The separation efficiency of the column set is calibrated with a calibration curve generated using a seventeen individual polystyrene standards ranging in Mp from about 580 to about 10,000,000, which is used to generate the calibration curve. The polystyrene standards are obtained from Polymer Laboratories (Amherst, Mass.). A calibration curve (log Mp vs. retention volume) is generated by recording the retention volume at the peak in the DRI signal for each PS standard, and fitting this data set to a 2nd-order polynomial. Samples are analyzed using IGOR Pro, available from Wave Metrics, Inc.

### Diluents Used to Produce the Multi-Layer, Microporous Membrane

The first, second, and third diluents can be, e.g., one or more of aliphatic, alicyclic or aromatic hydrocarbons such as nonane, decane, decalin, p-xylene, undecane, dodecene; liquid paraffin; and mineral oil distillates having boiling points comparable to those of the preceding hydrocarbons. Although it is not required, the first, second, and third diluents can be the same diluent or diluent mixture. The diluent may be a non-volatile liquid solvent (or mixture thereof) for the polymers used to produce the extrudate. The diluent's viscosity is generally in the range of from about 30 cSt to about 500 cSt, or from about 30 cSt to about 200 cSt, when measured at a temperature of 25° C. Although the choice of viscosity is not particularly critical, when the viscosity at 25° C. is less than about 30 cSt, the mixture of polymer and diluent might foam, resulting in difficulty in blending. On the other hand, when the viscosity is more than about 500 cSt, it can be more difficult to remove the solvent from the extrudate.

The amount of diluent in the extrudate can be, e.g., from about 25.0 wt. % to about 90.0 wt. % or 60.0 wt. % to 80.0 wt. % based on the weight of the extrudate, with the balance being the polymer used to produce the extrudate. The extrudate may contain an amount of diluent of about 65.0 wt. % to 80.0 wt. %, or about 70.0 wt. % to 75.0 wt. %, based on the weight of the extrudate. The extrudate may be produced from polyethylene and diluent only.

While the extrudate and the microporous membrane can contain copolymers, inorganic species (such as species containing silicon and/or aluminum atoms), and/or heat-resistant polymers such as those described in PCT Publications WO 2007/132942 and WO 2008/016174, these are not required. The extrudate and membrane may be substantially free of such materials. Substantially free in this context means the amount of such materials in the microporous membrane is ≦1.0 wt. %, based on the total weight of the polymer used to produce the extrudate.

The final microporous membrane generally comprises the polymer used to produce the extrudate. A small amount of diluent or other species introduced during processing can also be present, generally in amounts ≦1.0 wt. % based on the weight of the microporous polyolefin membrane. A small amount of polymer molecular weight degradation might occur during processing, but this is acceptable. Molecular weight degradation during processing, if any, may cause the MWD of the polymer in the membrane to differ from the MWD of the polymer used to produce the membrane (before extrusion) by ≦10.0%, e.g., about 1.0%, or ≦0.1%.

### (3) METHOD FOR PRODUCING THE MULTI-LAYER, MICROPOROUS POLYOLEFIN MEMBRANE

The multi-layer microporous membrane may comprise first and second microporous layers constituting the outer layers of the microporous membrane and a third layer situated between the first and second layers. The first layer is produced from PE1, the second layer is produced from PE2, and the third layer is produced from PE3.

One method for producing a multi-layer membrane comprises the steps of (1) (a) combining at least PE1 and a first diluent, the PE1 having an Mw<1.0×10⁶ and an amount of terminal unsaturation <0.20 per 10,000 carbon atoms, and (b) combining at least PE2 and a second diluent, the PE2 having an Mw<1.0×10⁶ and an amount of terminal unsaturation <0.20 per 10,000 carbon atoms; (2) combining at least a PE3 and a third diluent; the PE3 having an Mw<1.0×10⁶ and an amount of terminal unsaturation ≧0.20 per 10,000 carbon atoms; (3) extruding at least a portion of the combined PE1 and first diluent, at least a portion of the combined PE2 and the second diluent, and at least a portion of the combined PE3 and third diluent to form a multi-layer extrudate having first and third layers containing the PE 1 and PE2, respectively, and a third layer containing PE3, the third layer being located between the first and third layers and the total amount of polyethylene in the extrudate having a terminal unsaturation of 0.20 per 10,000 carbon atoms being in the range of 4.0 wt. % to 35.0 wt. % based on the total weight of polyethylene in the extrudate, and (4) removing at least a portion of the first, second, and third diluents from the stretched multi-layer extrudate to produce the multi-layer microporous membrane. The size of the membrane in the transverse (TD) direction can be called the first dry width and the size of the membrane in the machine direction (MD) can be called the first dry length. If desired, the method can further comprise (5) stretching the dried extrudate in TD from the first dry width to a second dry width, that is larger than the first dry width by a magnification factor of from about 1.20 to 1.40, without changing the first dry length to produce a stretched membrane. The stretching can be conducted while exposing the dried extrudate to a temperature of 124.0° C. to 130.1° C., for example, from 125.0° C. to 129.0° C.

Additional optional steps that are generally useful in the production of microporous membranes can be used. For example, an optional extrudate cooling step, an optional extrudate stretching step, an optional hot solvent treatment step, an optional heat setting step, an optional cross-linking step with ionizing radiation, an optional hydrophilic treatment step and the like, all as described in PCT Publications WO 2007/132942 and WO 2008/016174 can be conducted if desired. Neither the number nor order of these optional steps is critical.

### Combining Polymer and Diluent

The polymers as described above can be combined, e.g., by dry mixing or melt blending, and then this mixture can be combined with an appropriate diluent (or mixture of diluents) to produce a mixture of polymer and diluent. Alternatively, the polymer(s) and diluent can be combined in a single step. The first, second, and third diluents can be the same, e.g., liquid paraffin. When the diluent is a solvent for one or more of the polymers, the mixture can be called a polymeric solution. The mixture can contain additives such as one or more antioxidant. The amount of such additives may not exceed 1 wt. % based on the weight of the polymeric solution. The choice of mixing conditions, extrusion conditions and the like can be the same as those disclosed in PCT Publication No. WO 2008/016174, for example. Optionally, (a) the amount of first polyethylene combined with first diluent is 25.0 wt. % to 30.0 wt. % and the amount of first diluent is 70.0 wt. % to 75 wt. %, both weight percents being based on the combined first polyethylene and first diluent; and (b) the amount of third polyethylene combined with third diluent is about 20.0 wt. % to 30.0 wt. % and the amount of third diluent is 70.0 wt. % to 80.0 wt. %, both weight percents being based on the combined third polyethylene and third diluent.

Optionally, the second polyethylene is the same polyethylene as the first polyethylene and the first diluent is the same as the second diluent; the first and second layers contain 17.25 wt. % to 22.5 wt. % of the first polyethylene, 70.0 wt. % to 75.0 wt. % of the first diluent and 6.25 wt. % to 9.3 wt. % of the fourth polyethylene; and the third layer contains 13.8 wt. % to 24.9 wt. % of the third polyethylene, 70.0 wt. % to 80.0 wt. % of the third diluent and 3.4 wt. % to 9.3 wt. % of the fourth polyethylene, the third diluent being the same as the first and second diluents.

### Extrusion

The combined polymer and diluent may be conducted from an extruder to a die.

The extrudate or cooled extrudate (as hereinafter described) should have an appropriate thickness to produce, after the stretching steps, a final membrane having the desired thickness. For example, the extrudate can have a thickness of about 0.2 mm to 2 mm, or 0.7 mm to 1.8 mm. Process conditions for accomplishing this extrusion can be the same as those disclosed in PCT Publications WO 2007/132942 and WO 2008/016174, for example. The machine direction (“MD”) is defined as the direction in which the extrudate is produced from the die. The transverse direction (“TD”) is defined as the direction perpendicular to both MD and the thickness direction of the extrudate. The extrudate can be produced continuously from a die, or it can be produced discontinuously as is the case in batch processing, for example. The definitions of TD and MD are the same in both batch and continuous processing. While the extrudate can be produced by coextruding (a) the combined PE1 (and optionally PE4) with the first diluent, (b) PE2 (and optionally PE4) with the second diluent, and (c) PE3 (and optionally PE4) with the third diluent, this is not required. Any method capable of producing a layered extrudate of the foregoing composition can be used, e.g., lamination. When lamination is used to produce the membrane, the diluent(s) can be removed before or after the lamination.

### Optional Cooling

If desired, the multi-layer extrudate can be exposed to a temperature of 15° C. to 45° C. to form a cooled extrudate. Cooling rate is not particularly critical. For example, the extrudate can be cooled at a cooling rate of at least about 30° C./minute until the temperature of the extrudate (the cooled temperature) is approximately equal to the extrudate's gelation temperature (or lower). Process conditions for cooling can be the same as those disclosed in PCT Publications No. WO 2008/016174 and WO 2007/132942, for example. The cooled extrudate may have a thickness of 1.2 mm to 1.8 mm, or 1.3 mm to 1.7 mm.

### Optional Stretching

If desired, the extrudate or cooled extrudate can be stretched in at least one direction (e.g., at least one planar direction such as MD or TD) to produce a stretched extrudate. For example, the extrudate can be stretched simultaneously in MD and TD to a magnification factor of 4 to 6 while exposing the extrudate to a temperature of about 110° C. to 120° C., e.g., 114° C. to 118° C. The stretching temperature may be 115° C. Suitable stretching methods are described in PCT Publications No. WO 2008/016174 and WO 2007/132942, for example. While not required, the MD and TD magnifications can be the same. The stretching magnification may be equal to 5 in MD and TD and the stretching temperature is 115.0° C. The magnification factor operates multiplicatively on film size. For example, a film having an initial width (TD) of 2.0 cm that is stretched in TD to a magnification factor of 4 fold will have a final width of 8.0 cm. The stretched extrudate may undergo an optional thermal treatment before diluent removal. In the thermal treatment, the stretched extrudate is exposed to a temperature that is higher (warmer) than the temperature to which the extrudate is exposed during stretching. The planar dimensions of the stretched extrudate (length in MD and width in TD) can be held constant while the stretched extrudate is exposed to the higher temperature. Since the extrudate contains polymer and diluent, its length and width are referred to as the “wet” length and “wet” width. The stretched extrudate may be exposed to a temperature of 120° C. to 125° C. for a time of 1 second to 100 seconds while the wet length and wet width are held constant, e.g., by using tenter clips to hold the stretched extrudate along its perimeter. In other words, during the thermal treatment, there is no magnification or demagnification of the stretched extrudate in MD or TD.

### Diluent Removal

At least a portion of the diluents are removed (or displaced) from the stretched extrudate to form the membrane. A displacing (or “washing”) solvent can be used to remove (wash away, or displace) the diluent, as described in PCT Publications No. WO 2008/016174 and WO 2007/132942, for example. It is not necessary to remove all diluent from the stretched extrudate, although it can be desirable to do so since removing diluent increases the porosity of the final membrane.

At least a portion of any remaining volatile species such as washing solvent, can be removed from the membrane at any time after diluent removal. Any method capable of removing the washing solvent can be used, including conventional methods such as heat-drying, wind-drying (moving air) and the like. Process conditions for removing volatile species such as washing solvent can be the same as those disclosed in PCT Publications No. WO 2008/016174 and WO 2007/132942, for example.

### Optional Stretching of the Membrane (Dry Orientation)

The membrane can be stretched to produce a stretched membrane. At the start of this step, the membrane has an initial size in MD (a first dry length) and an initial size in TD (a first dry width). The membrane is stretched in TD from the first dry width to a second dry width that is larger than the first dry width by a magnification factor of from about 1.2 to about 1.4 (e.g., 1.25 to 1.35), without changing the first dry length. The stretching is conducted while exposing the membrane to a temperature of 124° C. to 130° C., e.g., 125.0° C. to 129.0° C. The magnification factor may be 1.3 and the temperature may be 126.7° C.

As used herein, the term “first dry width” refers to the size of the dried extrudate in the transverse direction prior to the start of dry orientation. The term “first dry length” refers to the size of the dried extrudate in the machine direction prior to the start of dry orientation.

The stretching rate is preferably 1%/second or more in TD. The stretching rate is preferably 2%/second or more, more preferably 3%/second or more, e.g., 2%/second to 10%/second. Though not particularly critical, the upper limit of the stretching rate is generally about 50%/second.

### Decreasing the Membrane's Width

The membrane can be subjected to a controlled reduction in width from the second dry width to a third dry width, the third dry width being from a factor of 1.0 times the first dry width to about 1.39 times the first width. Preferably, the third width is from 1.1 times larger than the first width to 1.3 times larger than the first dry width. The dry width can be reduced while the membrane is exposed to a temperature that is higher (warmer) than the temperature to which the dried extrudate was exposed in step (6), although this is not required. The membrane may be exposed to a temperature of, e.g., 124.0° C. to 130.0° C., or 125.0° C. to 129.0° C.

### Heat Set

If desired, the extrudate and/or membrane of can be thermally treated (heat-set), e.g., to stabilize crystals and make uniform lamellas in the membrane. The heat-setting step when used can be conducted by conventional methods such as tenter or roll methods. The heat-setting can be conducted, e.g., by maintaining the first dry length and the second or third dry width constant (e.g., by holding the membrane's edges with tenter clips), while exposing the membrane to a temperature of 125.0° C. to 130.0° C., e.g., 124.5° C. to 127.5° C. for a time in the range of 1 to 1000 seconds, or 10.0 to 100.0 sec. The heat setting temperature may be 126.7° C., and is conducted under conventional heat-set “thermal fixation” conditions, i.e., with no change in the membrane's planar dimensions. It is believed that exposing the membrane to a temperature that is higher than the temperature to which the membrane is exposed during the stretching generally produces a membrane having reduced TD heat shrinkage.

Optionally, an annealing treatment can be conducted before, during, or after the heat-setting. The annealing is a heat treatment with no load applied to the microporous membrane, and may be conducted by using, e.g., a heating chamber with a belt conveyer or an air-floating-type heating chamber. The annealing may also be conducted continuously after the heat-setting with the tenter slackened. The annealing temperature is preferably from about 126.5° C. to 129.0° C. Annealing is believed to provide the microporous membrane with improved heat shrinkage and strength.

Optional heated roller, hot solvent, cross linking, hydrophilizing, and coating treat-ments can be conducted if desired, e.g., as described in PCT Publication No. WO 2008/016174.

### (4) MEMBRANE PROPERTIES

The microporous polyethylene membrane may have relatively low shutdown temperature ≦133.0° C. and an electrochemical stability characterized by a self-discharge capacity of ≦90.0 mAh under the conditions hereinafter described. The membrane generally has a thickness of about 3.0 μm to about 2.0×10² μm, or about 5.0 μm to about 50.0 μM, and preferably 15.0 μm to about 25.0 μm. The thickness of the microporous membrane can be measured by a contact thickness meter at 1.0 cm longitudinal intervals over the width of 20.0 cm, and then averaged to yield the membrane thickness. Thickness meters such as the Litematic available from Mitsutoyo Corporation are suitable. This method is also suitable for measuring thickness variation after heat compression, as described below. Non-contact thickness measurements are also suitable, e.g., optical thickness measurement methods. The membrane can be a multilayer membrane and, in particular, can be a three-layer membrane.

In addition, the membrane can have one or more of the following characteristics.

### A. Shutdown Temperature <133.0° C.

The shutdown temperature of the microporous membrane is measured by a thermomechanical analyzer (TMA/SS6000 available from Seiko Instruments, Inc.) as follows: A rectangular sample of 3 mm×100 mm is cut out of the microporous membrane such that the long axis of the sample is aligned with the transverse direction of the microporous membrane and the short axis is aligned with the machine direction. The sample is set in the thermomechanical analyzer at a chuck distance of 10 mm, i.e., the distance from the upper chuck to the lower chuck is 10 mm. The lower chuck is fixed and a load of 19.6 mN applied to the sample at the upper chuck. The chucks and sample are enclosed in a tube which can be heated. Starting at 30° C., the temperature inside the tube is elevated at a rate of 5° C./minute, and sample length change under the 19.6 mN load is measured at intervals of 0.5 second and recorded as temperature is increased. The temperature is increased to 200° C., “Shutdown temperature” is defined as the temperature of the inflection point observed at approximately the melting point of the polymer having the lowest melting point among the polymers used to produce the membrane. The membrane's shutdown temperature may be <132.0° C., e.g., 128.0° C. to 132.0° C.

### B. A Self-Discharge Capacity of ≦110.0 mAh

Self-discharge capacity is a property of the membrane related to the membrane's electrochemical stability when the membrane is used as a battery separator and the battery is exposed to relatively high-temperature storage and use. Self-discharge capacity has the units of ampere hour. Smaller ampere hour values, representing less self-discharge capacity during high-temperature storage and use, are generally desired, particularly in high-power, high-capacity batteries such as those used to power portable computing equipment, mobile telephones, power tools, power electric vehicles and hybrid electric vehicles. It is also desired that such batteries exhibit a voltage drop ≦0.3 volts since those relatively high power, high-capacity battery applications are particularly sensitive to any loss in battery voltage. For example, it has been observed that a voltage drop >0.3 volts (e.g., battery electromotive force (“EMF”)) decreasing from an EMF of 4.3 V to an EMF <4.0 V can result in significant battery damage. It is believed that battery voltage drop is also related to the battery separator's electrochemical stability. Moreover, since the amount of power supplied by the battery is equal to V²/R, where V is the battery voltage and R is the equivalent DC load resistance, the amount of electric power supplied by the battery is very sensitive to even a small decrease in battery voltage. The membranes are useful in batteries capable of supplying ≧1.0 Ah, e.g., 2.0 Ah to 3.6 Ah, i.e., high-capacity batteries. Optionally, the separator has a self-discharge capacity <75.0 mAh, e.g., in the range of 10.0 mAh to 70.0 mAh, and/or a voltage drop of 0.01 V to 0.25 V such as 0.05 V to 0.2 V.

To measure membrane battery voltage drop and/or self-discharge capacity, a membrane having a length (MD) of 70 mm and a width (TD) of 60 mm is located between an anode and cathode having the same planar dimensions as the membrane. The anode is made of natural graphite and the cathode is made of LiCoO₂. An electrolyte is prepared dissolving LiPF₆ into mixture of ethylene carbonate (EC) and methylethyl carbonate (EMC) (4/6, V/V) as 1 M solution. The electrolyte is impregnated into the membrane in the region between the anode and the cathode to complete the battery.

The battery is charged to a voltage of 4.2 V at a temperature of 23° C. The battery is then exposed to a temperature of 60° C. for 24 hours, and the battery voltage is then measured. The battery's voltage drop is defined as the difference between 4.2 V and the battery voltage measured after storage.

The battery's self-discharge capacity is measured as follows using an electrochemical cell comprising an anode, cathode, separator, and electrolyte. The cathode is a 40 mm×40 mm sheet comprising an LiCoO₂ layer having a mass per unit area of 13.4 mg/cm² and a density of 1.9 g/cm³ of density on an aluminum substrate, the substrate having a thickness of 15 μm. The anode is a 40 mm×40 mm sheet comprising natural graphite having a mass per unit area of 5.5 mg/cm² and a density of 1.1 g/cm³ on a copper film substrate, the substrate having a thickness of 10 μm. The anode and cathode are dried in vacuum oven at 120° C. before assembling the cell. The separator is a microporous membrane having a length of 60 mm and a width of 140 mm. The separator is dried in vacuum oven at 50° C. before assembling the cell. The electrolyte is prepared by dissolving LiPF₆ into a mixture of ethylene carbonate and methylethyl carbonate (4/6, V/V) to form a 1 M solution. The cell is produced by stacking the anode, separator, and cathode between first and second aluminized polymer sheets (the aluminum of the first sheet being in contact with the cathode and the aluminum of the second sheet being in contact with the anode), impregnating the separator with the electrolyte, and then hermetically sealing (by heating) the first and second aluminized polymer sheets along the cell's perimeter. Leads connected to the first and second aluminized polymer sheets provide for, e.g., charging and discharging the cell. The cell is then tested to confirm that it is functioning properly by the following charge-discharge process. The cell is located between silicon rubber sheets and charged to a voltage of 4.2 V at a substantially constant current of 10 mA while exposed to a temperature of 23° C. The cell is then discharged to voltage reaching 3.0 V at a substantially constant current of 6.0 mA while measuring the integrated current supplied by the cell. Functioning cells exhibit an integrated current ≧23 mAh. Functioning cells are used to determine the battery's self-discharge capacity, and the non-functioning cells can be discarded. The battery's self-discharge capacity is measured by subjecting a functioning cell to trickle charging at a substantially constant current of 16 mA while exposing the cell to a temperature of 60° C. The self-discharge capacity is equal to the total current supplied to the battery integrated over a 120 hour test period, and is expressed in units of Ampere-hours.

C. Air Permeability 15 Seconds/100 cm³ (Normalized to a 1.0 μm Membrane Thickness)

The membrane's air permeability value is normalized to the value for an equivalent membrane having a film thickness of 1.0 μm. The membrane's air permeability value is thus expressed in units of “seconds/100 cm³/1.0 μm.” Normalized air permeability is measured according to JIS P8117, and the results are normalized to the permeability value of an equivalent membrane having a thickness of 1.0 μm using the equation A=1.0 μm*(X)/T₁, where X is the measured air permeability of a membrane having an actual thickness T₁ and A is the normalized air permeability of an equivalent membrane having a thickness of 1.0 μm.

The air permeability of the microporous membrane may be 15 seconds/100 cm³/μm or ≦10.0 seconds/100 cm³/μm, e.g., from 5.0 to 15.0 seconds/100 cm³/μm. When the air permeability is more than about 20 seconds/100 cm³/μm, it is more difficult to produce a battery having the desired shutdown characteristics, particularly when the temperatures inside the batteries are elevated.

D. Pin Puncture Strength 235 mN/μm

Pin puncture strength is defined as the maximum load measured (in milliNewtons or “mN”) when a microporous membrane having a thickness of T₁ is pricked with a needle of 1 mm in diameter with a spherical end surface (radius R of curvature: 0.5 mm) at a speed of 2 mm/second. The pin puncture strength is normalized to a value at a membrane thickness of 1.0 μm using the equation L₂=(L₁)/T₁, where L₁ is the measured pin puncture strength, L₂ is the normalized pin puncture strength, and T₁ is the average thickness of the membrane.

The membrane may have a normalized pin puncture strength 245 mN/μm, or 265 mN/μm, or 275 mN/μm, e.g., in the range of 245 mN/μm to 3.0×10² mN/μm.

E. Porosity of about 25% to about 80%

The membrane's porosity is measured conventionally by comparing the membrane's actual weight to the weight of an equivalent non-porous membrane of 100% polymer (equivalent in the sense of having the same polymer length, width, and thickness). Porosity is then determined using the formula: Porosity %=100×(w2−w1)/w2, wherein “w1” is the actual weight of the microporous membrane and “w2” is the weight of an equivalent non-porous membrane of 100% polymer having the same size and thickness. The membrane may have porosity of about 30% to about 50%.

### F. Meltdown Temperature 145° C.

Meltdown temperature is measured by the following procedure: A rectangular sample of 3 mm×100 mm is cut out of the microporous membrane such that the long axis of the sample is aligned with the transverse direction of the microporous membrane as it is produced in the process and the short axis is aligned with the machine direction. The sample is set in the thermomechanical analyzer (TMA/SS6000 available from Seiko Instruments, Inc.) at a chuck distance of 10 mm, i.e., the distance from the upper chuck to the lower chuck is 10 mm. The lower chuck is fixed and a load of 19.6 mN applied to the sample at the upper chuck. The chucks and sample are enclosed in a tube which can be heated. Starting at 30° C., the temperature inside the tube is elevated at a rate of 5° C./minute, and sample length change under the 19.6 mN load is measured at intervals of 0.5 second and recorded as temperature is increased. The temperature is increased to 200° C. The meltdown temperature of the sample is defined as the temperature at which the sample breaks, generally at a temperature in the range of about 145° C. to about 200° C.—

The meltdown temperature may be 148° C., e.g., from 148° C. to 151° C.

### G. MD Heat Shrinkage Ratio at 105° C.≦5.5%; TD Heat Shrinkage Ratio at 105° C.≦4.0%

The shrinkage ratio of the microporous membrane in orthogonal planar directions (e.g., TD and MD) at 105° C. is measured as follows: (i) Measure the size of a test piece of the microporous membrane at ambient temperature in both MD and TD, (ii) equilibrate the test piece of the microporous membrane at a temperature of 105° C. for 8 hours with no applied load, and then (iii) measure the size of the membrane in both MD and TD. The heat (or “thermal”) shrinkage ratio in either MD or TD can be obtained by dividing the result of measurement (i) by the result of measurement (ii) and expressing the resulting quotient as a percent.

The microporous membrane may have an MD heat shrinkage ratio at 105° C., of 1.0% to 5.0%, e.g., 2.0% to 4.0% and a TD heat shrinkage ratio at 105° C.≦3.5%, e.g., 0.5% to 3.5% or about 1.0% to 3.0%.

### (5) BATTERY

The microporous membranes are useful as battery separators in, e.g., lithium ion primary and secondary batteries. Such batteries are described in PCT publication WO 2008/016174.

The battery is useful as a power source for one or more electrical or electronic components. Such components include passive components such as resistors, capacitors, inductors, including, e.g., transformers; electromotive devices such as electric motors and electric generators, and electronic devices such as diodes, transistors, and integrated circuits. The components can be connected to the battery in series and/or parallel electrical circuits to form a battery system. The circuits can be connected to the battery directly or indirectly. For example, electrical energy produced by the battery can be converted electrochemically (e.g., by a second battery or fuel cell) and/or electromechanically (e.g., by an electric motor operating an electric generator) before the electrical energy is dissipated or stored in a one or more of the components. The battery system can be used as a power source to power relatively high power devices such as electric motors for driving power tools and electric or hybrid electric vehicles.

### (6) EXAMPLES

My membranes, methods and uses will be explained in more detail referring to the following non-limiting examples.

### Example 1

### Preparation of Skin Layer Polyethylene Solution

The skin layers are produced from a polyethylene mixture comprising (a) 70.0 wt. % of PE1 having an Mw of 5.6×10⁵ and an amount of terminal unsaturation <0.20 per 10,000 carbon atoms, (b) 30% of PE4 having an Mw of 2.0×10⁶ and an MWD of 5.1. The polyethylene in the mixture has a melting point of 135° C.

The polymer solution used to produce the skin layers is prepared by combining 28.5 wt. % of the polyethylene mixture (PE2 is the same as PE1) and 71.5 wt. % of liquid paraffin (50 cst at 40° C.) in a strong-blending extruder, the weight percents being based on the total weight of the polymer solution used to produce the skin layers. The polymer and diluent are combined at a temperature of 210° C.

### Preparation of the Core Layer Polyethylene Solution

A core-layer polymer solution is produced from a polyethylene mixture comprising (a) 70.0 wt. % of PE3 having an Mw of 7.5×10⁵ and an amount of terminal unsaturation >0.20 per 10,000 carbon atoms and (b) 30.0% of PE4 having an Mw of 2.0×10⁶ and an MWD of 5, which is prepared by dry-blending. The polyethylene in the mixture has a melting point of 135° C. The polymer solution used to produce the core layer is prepared by combining 25 wt. % of the core layer polyethylene mixture and 75 wt. % of liquid paraffin (50 cst at 40° C.) in a strong-blending extruder, the weight percents being based on the total weight of the polymer solution used to produce the core layer. The polymer and diluent are combined at a temperature of 210° C.

### Production of Membrane

The polymer solutions are supplied from their respective double-screw extruders to a three-layer-extruding T-die, and extruded therefrom to form an extrudate at a layer thickness ratio of 42.5/15/42.5 (skin/core/skin). The extrudate is cooled while passing through cooling rollers controlled at 20° C., to form a three-layer extrudate (in the form of a gel-like sheet), which is simultaneously biaxially stretched at 115° C. to a magnification of 5 fold in both MD and TD by a tenter-stretching machine. The stretched extrudate is then immersed in a bath of methylene chloride at 25° C. to remove the liquid paraffin to an amount of 1 wt. % or less based on the weight of liquid paraffin present in the polyolefin solution, and then dried by flowing air at room temperature. The dried extrudate is stretched (dry orientation) to a magnification of 1.3 fold in TD while exposed to a temperature of 126.7° C. and sequentially contracted to a magnification of 1.2 fold in TD while exposed to a temperature of 126.7° C. Following stretching, the dried membrane is heat-set by a tenter-type machine while exposed to a temperature of 126.7° C. for 26 seconds to produce a three-layer microporous membrane.

### Examples 2-6

Example 1 is repeated except as noted in Table 1.

### Comparative Examples 1-3

Example 1 is repeated except as noted in Table 1.

TABLE 1

| No | | | | | |
|---|---|---|---|---|---|
| Ex 1 | Ex 2 | Ex 3 | Ex 4 | Ex 5 | Ex 6 |

Skin Polyethylene

| PE1 | Mw | 5.6 × 10⁵ | 5.6 × 10⁵ | 5.6 × 10⁵ | 5.6 × 10⁵ | 5.6 × 10⁵ | 5.6 × 10⁵ |
|---|---|---|---|---|---|---|---|
| | MWD | 4.1 | 4.1 | 4.1 | 4.1 | 4.1 | 4.1 |
| | % by mass | 70 | 70 | 70 | 70 | 70 | 70 |
| PE4 | Mw | 2.0 × 10⁶ | 2.0 × 10⁶ | 2.0 × 10⁶ | 2.0 × 10⁶ | 2.0 × 10⁶ | 2.0 × 10⁶ |
| | MWD | 5.1 | 5.1 | 5.1 | 5.1 | 5.1 | 5.1 |
| | % by mass | 30 | 30 | 30 | 30 | 30 | 30 |
| Conc. of PO % by mass | | 28.5 | 28.5 | 28.5 | 28.5 | 28.5 | 28.5 |
| Core Polyethylene | | | | | | | |
| PE3 | Mw | 7.5 × 10⁵ | 7.5 × 10⁵ | 7.5 × 10⁵ | 7.5 × 10⁵ | 7.5 × 10⁵ | 7.5 × 10⁵ |
| | MWD | 11.8 | 11.8 | 11.8 | 11.8 | 11.8 | 11.8 |
| | % by mass | 70 | 70 | 70 | 82 | 82 | 82 |
| PE4 | Mw | 2.0 × 10⁶ | 2.0 × 10⁶ | 2.0 × 10⁶ | 2.0 × 10⁶ | 2.0 × 10⁶ | 2.0 × 10⁶ |
| | MWD | 5.1 | 5.1 | 5.1 | 5.1 | 5.1 | 5.1 |
| | % by mass | 30 | 30 | 30 | 18 | 18 | 18 |

| | | | | | | |
|---|---|---|---|---|---|---|
| Conc. of PO Comp. % by mass | 25 | 25 | 25 | 30 | 30 | 30 |

Total membrane composition

| Layer structure | | (I)/(II)/(I) | (I)/(II)/(I) | (I)/(II)/(I) | (I)/(II)/(I) | (I)/(II)/(I) | (I)/(II)/(I) |
|---|---|---|---|---|---|---|---|
| Resin amount ratio | | 42.5/15/42.5 | 45/10/45 | 40/20/40 | 47.5/5/47.5 | 40/20/40 | 34.5/31/34.5 |
| PE1 | % by mass | 59 | 63 | 56 | 66 | 56 | 48.2 |
| PE3 | % by mass | 11 | 7 | 14 | 4 | 16 | 25.5 |
| PE4 | % by mass | 30 | 30 | 30 | 30 | 28 | 26.3 |

| | | | | | | |
|---|---|---|---|---|---|---|
| Stretching of Gel-Like sheet | | | | | | |
| Temperature (° C.) | 115 | 115 | 115 | 115 | 115 | 115.0 |
| Magnification (MD × TD) | 5 × 5 | 5 × 5 | 5 × 5 | 5 × 5 | 5 × 5 | 5 × 5 |
| Stretching of dried membrane | | | | | | |
| Temperature (° C.) | 126.7 | 127.0 | 126.5 | 127.0 | 127.0 | 124.7 |
| Magnification (TD) | 1.3 -> 1.2 | 1.3 -> 1.2 | 1.3 -> 1.2 | 1.3 -> 1.2 | 1.3 -> 1.2 | 1.3 -> 1.1 |
| Heat setting treatment | | | | | | |
| Temperature (° C.) | 126.7 | 127.0 | 126.5 | 127.0 | 127.0 | 124.7 |
| Time (sec) | 26 | 26 | 26 | 26 | 26 | 26 |
| Average thickness (μm) | 20 | 20 | 20 | 20 | 20 | 20 |
| Air Permeability (sec/100 cm³/μm) | 13.5 | 13.5 | 13.5 | 14.0 | 13.5 | 12.0 |
| Porosity % | 43 | 43 | 44 | 43 | 42 | 44 |
| Tensile strength MD/TD (kg/cm²) | 1500/1600 | 1500/1600 | 1500/1600 | 1550/1600 | 1500/1550 | 1400/1300 |
| Puncture Strength (mN/μm) | 261 | 263 | 274 | 256 | 245 | 235 |
| Heat shrinkage MD/TD (%) | 4.5/4.0 | 4.5/3.5 | 4.5/4.0 | 4.5/3.5 | 4.0/3.0 | 5.0/1.5 |
| Shutdown Temp. ° C. | 131.6 | 131.1 | 131.4 | 131.3 | 131.0 | 131.3 |
| Meltdown Temp. ° C. | 149.6 | 149.4 | 149.9 | 149.5 | 149.6 | 150.1 |
| Self-discharge capacity (mAh) | 57 | 86 | 76 | 74 | 71 | 59 |

| | | No | | |
|---|---|---|---|---|
| | | Comp. Ex 1 | Comp. Ex 2 | Comp. Ex 3 |
| Skin Polyethylene (I) | | | | |
| PE1 | Mw | — | 5.6 × 10⁵ | 5.6 × 10⁵ |
| | MWD | — | 4.1 | 4.1 |
| | % by mass | — | 70 | 70 |
| PE4 | Mw | — | 2.0 × 10⁶ | 2.0 × 10⁶ |
| | MWD | — | 5.1 | 5.1 |
| | % by mass | — | 30 | 30 |
| Conc. of PO Comp. % by mass | | — | 28.5 | 28.5 |
| Core Polyethylene | | | | |
| PE3 | Mw | 7.5 × 10⁵ | — | 7.5 × 10⁵ |
| | MWD | 11.8 | — | 11.8 |
| | % by mass | 82 | | 82 |
| PE4 | Mw | 2.0 × 10⁶ | — | 2.0 × 10⁶ |
| | MWD | 5.1 | — | 5.1 |
| | % by mass | 18 | — | 18 |
| Conc. of PO Comp. % by mass | | 30 | — | 25 |
| Total membrane composition | | | | |
| Layer structure | | (II) | (I) | (II)/(I)/(II) |
| Resin amount ratio | | — | — | 33.5/33/33.5 |
| PE1 | % by mass | 0 | 70 | 26.9 |
| PE3 | % by mass | 82 | 0 | 47.0 |
| PE4 | % by mass | 18 | 30 | 26.1 |

| | | | |
|---|---|---|---|
| Stretching of Gel-Like sheet | | | |
| Temperature (° C.) | 114.4 | 114.0 | 114.0 |
| Magnification (MD × TD) | 5 × 5 | 5 × 5 | 5 × 5 |
| Stretching of dried membrane | | | |
| Temperature (° C.) | 124.7 | 128.0 | 125.0 |
| Magnification (TD) | 1.0 | 1.2 | 1.3 -> 1.2 |
| Heat setting treatment | | | |
| Temperature (° C.) | 127.5 | 128.0 | 125.0 |
| Time (sec) | 10 | 26 | 26 |
| Average thickness (μm) | 20 | 20 | 20 |
| Air Permeability (sec/100 cm³/μm) | 27.0 | 12.0 | 12.0 |
| Porosity % | 36 | 45 | 43 |
| Tensile strength MD/TD (kg/cm²) | 1500/1250 | 1500/1450 | 1200/1300 |
| Puncture Strength (mN/μm) | 235 | 260 | 212 |
| Heat shrinkage MD/TD (%) | 5.5/4.5 | 4.5/6.0 | 4.0/3.5 |
| Shutdown Temp. ° C. | 128.9 | 133.8 | 131.6 |
| Meltdown Temp. ° C. | 148.3 | 150.1 | 149.0 |
| Self-discharge capacity (mAh) | 145 | 54 | 230 |

Examples 1 to 6 show that microporous membranes having desirable shutdown temperature and electrochemical stability (self-discharge capacity) with desirable thermal and mechanical properties can be produced from polyolefin and liquid paraffin diluent. Table 1 shows that the membranes have both low shutdown temperature ≦133.0° C., a TD heat shrinkage ≦4.0%, and a self-discharge capacity <110.0 mAh. This improvement is achieved without significantly degrading other important membrane properties such as tensile strength, pin puncture strength, permeability, heat shrinkage and meltdown temperature. The membranes of the comparative examples, as shown in Table 1, exhibit one or more of undesirable shutdown temperature, undesirable electrochemical stability, or undesirable TD heat shrinkage. It is believed that the multilayer structure leads to better control of membrane thermal stability (e.g., TD heat shrinkage), which is significantly degraded in the monolayer film of comparable Example 2.

1. A method of producing a microporous membrane comprising:
combining at least a first polyethylene and a first diluent, the first polyethylene having an Mw≦1.0×10⁶ and an amount of terminal unsaturation <0.20 per 10,000 carbon atoms;
combining at least a second polyethylene and a second diluent, the second polyethylene having an Mw≦1.0×10⁶ and an amount of terminal unsaturation <0.20 per 10,000 carbon atoms;
combining at least a third polyethylene and a third diluent, the third polyethylene having an Mw≦1.0×10⁶ and an amount of terminal unsaturation ≧0.20 per 10,000 carbon atoms;
forming from the combined polyethylenes and diluents a multi-layer extrudate having a first layer containing the first polyethylene, a second layer containing the second polyethylene, and a third layer located between the first and second layers containing the third polyethylene, wherein the extrudate contains polyethylene having a terminal unsaturation ≧0.20 per 10,000 carbon atoms in an amount of 4.0 wt. % to 35.0 wt. % based on total weight of polymer in the extrudate; and
removing at least a portion of the first, second, and third diluents from the multi-layer extrudate to produce the membrane.

2. The method of claim 1, further comprising stretching the extrudate before removing at least portions of the diluent(s) and removing at least a portion of any volatile species from the membrane during or after removing at least portions of the diluent(s).

3. The method of claim 1, wherein
(a) the amount of first polyethylene combined with first diluent is about 25.0 to 30.0 wt. % and the amount of first diluent is 70.0 to 75.0 wt. %, both weight percents being based on the combined first polyethylene and first diluent; and
(b) the amount of third polyethylene combined with third diluent is about 20.0 to 30.0 wt. % and the amount of third diluent is 70.0 to 80.0 wt. %, both weight percents being based on the combined third polyethylene and third diluent.

4. The method of claim 1, further comprising combining a fourth polyethylene having a molecular weight ≧1.0×10⁶ with at least one of the first, second, or third polyethylenes.

5. The method of claim 1, wherein
the second and first polyethylenes are the same and the first and second diluents are the same;
the first and second layers contain 17.25 to 22.5 wt. % of the first polyethylene, 70.0 to 75.0 wt. % of the first diluent and 6.25 to 9.3 wt. % of the fourth polyethylene; and
the third layer contains 13.8 to 24.9 wt. % of the third polyethylene, 70 to 80 wt. % of the third diluent and 3.4 to 9.3 wt. % of the fourth polyethylene, the third diluent being the same as the first and second diluents.

6. The method of claim 1, further comprising cooling the multilayer extrudate following forming.

7. The method of claim 1, further comprising stretching the membrane in at least one direction.

8. The method of claim 6, wherein the membrane stretching is conducted while the membrane is exposed to a temperature of 90° C. to 135° C.

9. A multi-layer membrane made by the method of claim 1.
